(19) United States
(12) Patent Application Publication
(10) Pub. No.: US 2004/0238666 A1
(43) Pub. Date: Dec. 2, 2004

(54) Hammer with protective pocket

(76) Inventors: Paul R. Gray, New Providence, IA (US); Loran R. Balvanz, New Providence, IA (US)

Correspondence Address: Davis, Brown, Koehn, Shors & Roberts, P.C., The Financial Center, Suite 2500, 666 Walnut Street, Des Moines, IA, 50309-3993, US

(21) Appl. No.: 10/447,883

(22) Filed: May 29, 2003

(51) Int. Cl. B02C 13/28

(52) U.S. Cl. 241/197

(57) ABSTRACT

A hammer and hammer tip combination is provided for use with a size reducing machine, and comprises a hammer body having a nose extending up to and defining a lower edge of a debris path; a protective pocket located behind the nose relative to the debris path; and a hammer tip releaseably secured to the hammer body and located behind the protective pocket relative to the debris path.

### BACKGROUND OF THE INVENTION

The present invention relates to a hammer for use with a size-reducing machine. In particular, to a hammer with a protective pocket designed to reduce wear and increase the efficiency of operation.

Size reducing machines are well known in the art. These include rotary hammermills, cuttermills, horizontal and vertical feed machines and the like. All of these machines operate in similar manners. They typically employ a machine driven rotor with a plurality of hammers attached thereto. The hammers include inserts or hammer tips that extend into a debris path. As debris enters the machines it encounters the hammer tips and the impact begins to reduce or break up the debris into smaller more manageable pieces. Eventually, the pieces are reduced in size so that they exit the machine. Typically, the machines include a screen that allows material of sufficiently small size to fall through the screen thereby exiting the machine.

The repeated impact exposes certain parts of the machines to tremendous wear. These parts require frequent replacement due to wear and/or breakage. For this reason, wear parts like the hammer tips are normally coated with a material like tungsten carbide to better resist wear, however, even this protection is not sufficient to prevent excessive wear and damage and damage can occur to non-wear parts through secondary collision and impact.

As stated above, one of the problems associated with these types of machines is that debris impacts surfaces other than the hammer tips. These surfaces may not have protective coatings and experience greater wear, which undermines the effectiveness of the wear parts. It is not uncommon to have a hammer, or a portion of the hammer, wear or break out before the hammer tip due to secondary debris impact. This, of course, leads to operational inefficiencies and excessive repair to the machines.

Accordingly, a need exists for a hammer and hammer tip combination that better focuses debris impact on the wear surfaces.

### SUMMARY OF THE INVENTION

An object of the present invention comprises providing a hammer and hammer tip combination is provided for use with a size-reducing machine that better resists wear.

These and other objects of the present invention will become apparent to those skilled in the art upon reference to the following specification, drawings, and claims.

The present invention intends to overcome the difficulties encountered heretofore. To that end, a hammer and hammer tip combination is provided for use with a size reducing machine, and comprises a hammer body having a nose extending up to and defining a lower edge of a debris path; a protective pocket located behind the nose relative to the debris path; and a hammer tip releaseably secured to the hammer body and located behind the protective pocket relative to the debris path.

### BRIEF DESCRIPTION OF THE DRAWINGS

FIG. 1 is a side view of a hammer and hammer tip combination designed for use with a size reducing machine.

### DETAILED DESCRIPTION OF THE INVENTION

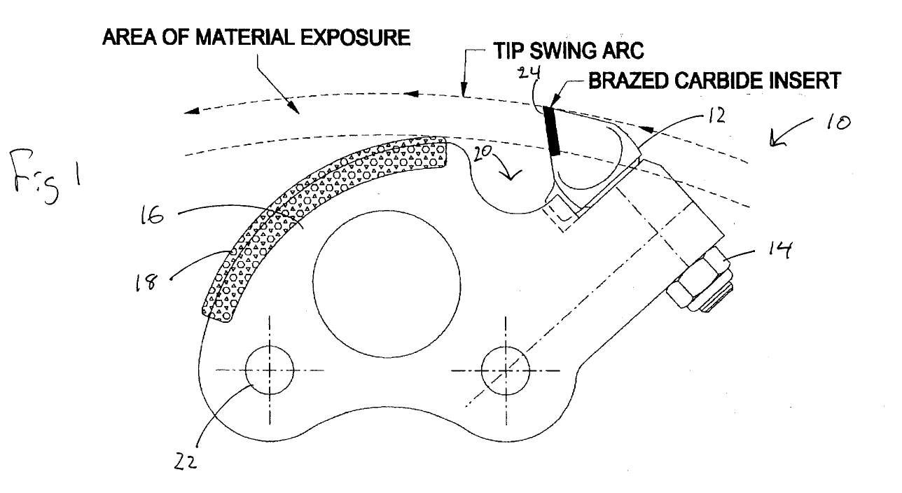

In the FIGURE, FIG. 1 shows a hammer 10 with a threaded bullet tip hammer tip 12 attached thereto with a nut 14. The hammer 10 includes a forward extending nose 16 that extends up to the edge of the debris path. The nose 16 includes a wear resistance coating 18, like tungsten carbide, to protect the hammer 10 from impact. A pocket 20 is formed between the nose 16 and the hammer tip 12. The hammer 10 includes holes 22 for securing the hammer 10 to a rotor (not shown). The working edge of the hammer tip 12 includes a wear resistant coating 24.

Configured in this manner, the hammer 10 focuses the debris impact on the hammer tip 12 and away from surfaces that are not designed for such impact. This prolongs the life of the hammer 10, by preventing impact below the hammer tip 12 that can cause damage or breakage. The design also serves to limit the bite size of the hammer tip 12, which increases the efficiency of operation and prolongs the life of the hammer 10 and hammer tip 12. Furthermore, the design tends to focus all of the debris impact on the hammer tip 12 and substantially reduces the problems associated with secondary impact occurring on surfaces that are not protected or designed for such impact.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

1. A hammer and hammer tip combination for use with a size reducing machine, comprising:
a hammer body having a nose extending up to and defining a lower edge of a debris path;
a protective pocket located behind said nose relative to said debris path; and
a hammer tip releaseably secured to said hammer body and located behind said protective pocket relative to said debris path.

2. The invention in accordance with claim 1 wherein said nose includes a wear resistant coating.

3. The invention in accordance with claim 1 wherein said hammer tip includes a wear resistant coating.
